(19) United States
(12) Patent Application Publication
(10) Pub. No.: US 2026/0034996 A1
(43) Pub. Date: Feb. 5, 2026

(54) USING MACHINE LEARNING TO CONTROL RESOURCE UTILIZATION

(71) Applicants: GM GLOBAL TECHNOLOGY OPERATIONS LLC, Detroit, MI (US); The Regents of the University of Michigan Innovation Partnerships, Ann Arbor, MI (US)

(72) Inventors: Jinzhu Chen, Troy, MI (US); Fan Bai, Ann Arbor, MI (US); Nick Farid, San Jose, CA (US); Armin Sarabi, Ann Arbor, MI (US); Mingyan Liu, Ann Arbor, MI (US)

(73) Assignees: GM GLOBAL TECHNOLOGY OPERATIONS LLC, Detroit, MI (US); The Regents of the University of Michigan Innovation Partnerships, Ann Arbor, MI (US)

(21) Appl. No.: 18/788,830

(22) Filed: Jul. 30, 2024

(51) Int. Cl. B60W 50/00; G06F 9/50

(52) U.S. Cl. CPC B60W 50/0097; G06F 9/5027; G06F 2209/5019

(57) ABSTRACT

An “aggregator” controls the allocation of scarce resources among competing demands within a target machine-control environment. Multiple machine-learning agents are initiated, each with its own initial resource-utilization-optimization model based on a pre-trained model. The machine-learning agents receive resource-utilization information from within the target environment. They then use the received information to modify their models in order to more optimally utilize the scarce resources. Each agent sends a prediction, based on the agent's modified model, to the aggregator. The aggregator uses the predictions it receives to update its own model and uses that updated aggregator model to control, at least to some extent, the allocation of the scarce resources within the target environment.

### INTRODUCTION

A modern machine-control environment (that is, an environment that includes, for example, a motor vehicle, a manufacturing plant, or a smart home) may include many sensors and actuators. Sensors, such as a thermometer or a camera, report on aspects of their environment, while actuators, such as an air conditioner (“AC”) or an electrical-charging point, act to change that environment in some way. Some devices, such as a thermostat, include both a sensor and an actuator.

Many of these sensors and actuators, herein collectively called “devices,” utilize resources, such as electrical energy, from their environment in order to do their work. Many of them also utilize communications resources to communicate with one another over a wired, wireless, optical, or other network. For example, they may be Internet of Things (“IoT”) devices. The proliferation of such devices may lead to competition among them for resources that are scarce within their environment.

### SUMMARY

According to certain aspects of the present disclosure, an “aggregator” controls the allocation of scarce resources among competing demands within a target machine-control environment. Multiple machine-learning agents are initiated, each with its own initial resource-utilization-optimization model based on a pre-trained model. The machine-learning agents receive resource-utilization information from within the target environment. They then use the received information to modify their models in order to more optimally utilize the scarce resources. Each agent sends a prediction, based on the agent's modified model, to the aggregator. The aggregator uses the predictions it receives to update its own model and uses that updated aggregator model to control, at least to some extent, the allocation of the scarce resources within the target environment.

Aspects of the present disclosure may be applied to a number of machine-control environments including, for example, a vehicle, a dwelling place, an industrial site such as a factory, a farm, a computer-server installation, and even to a set of personal devices (e.g., smart phone, headphones, fitness monitor, etc.) carried by one or more humans.

A type of resource whose use is reportable may be controlled. While electrical power and energy are used as examples in this disclosure, other resources may include cooling power, bandwidth on a communications channel, and computer-processing power.

In some embodiments, the updated aggregator model is trained for one particular operator within the machine-control environment. When, for example, the machine-control environment is a motor vehicle, the aggregator attempts to optimize utilization of the scarce resources as they are generally used by one driver. For another driver, even of the same vehicle, the aggregator may build a different model based on that other driver's typical resource utilization.

Machine learning is often a very slow process. To speed up the learning of the machine-learning agents, and from them the learning of the aggregator, the agents are each initialized with a pre-trained model. The pre-trained model may be based on numerous simulations run in a virtual environment attempting to account for a number of different operator preferences. Another type of pre-trained model may be based again on numerous simulations, but here the simulations are chosen to mimic certain operating characteristics of the particular operator now in the environment. The different agents in one environment are generally pre-trained slightly differently from one another. This difference helps to speed up the overall learning of the aggregator.

Several ways exist for the aggregator to build its updated model. In one exemplary way, the aggregator compares the predictions received from the machine-learning agents and selects the most commonly made prediction. Using a majority voting scheme, the agent that most often produces the most common prediction is chosen by the aggregator as the best agent, and that agent's model is taken over to be the aggregator's updated model. In another exemplary way, the aggregator runs one agent during a set period. The aggregator repeats this with the other agents. Once the agents have been run, the aggregator picks that agent whose performance was best, by some measure, and uses its model as the updated aggregator model.

The above procedures may be repeated indefinitely to continually update the aggregator model.

### BRIEF DESCRIPTION OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified diagram of a representative environment in which the techniques of the present disclosure may be practiced;

FIG. 2 is a flowchart of a method for a machine-learning agent to learn how to better model resource utilization in its environment;

FIGS. 3A and 3B are data-flow diagrams of a machine-learning agent receiving pre-trained model data;

FIG. 4 is a flowchart of a method for an aggregator to find and apply the best model from among those presented by several machine-learning agents;

FIG. 5 is a data-flow diagram of a machine-learning control system interacting with its environment;

FIG. 6 is a schematic showing an exemplary machine-learning control system and its connection to its environment implemented using deep reinforcement learning with two fully connected neural networks; and

FIG. 7 is a diagram showing multiple machine-control environments, multiple machine-learning control systems, and the model-selection process.

The drawings are not necessarily to scale and may present simplified representations of various features of the present disclosure. Details associated with such features are determined in part by a particular intended application and environment of use.

### DETAILED DESCRIPTION

The proliferation of connected devices leads to competition for limited resources. For example, in a server farm each added server consumes electricity, communications bandwidth, and cooling capacity. Information technology (“IT”) specialists thus design the server farm with this resource competition in mind and, from their position of centralized control, update resource-allocation methods as the farm grows.

In other examples, the competition is not so readily apparent. Multiple IoT devices may be casually added to a machine-control environment that is not carefully watched over by IT. As one example, consider a homeowner who installs a wireless security camera. Being wireless, the camera does not pose a drain on the electrical-power resources of the smart home, but it does consume some communications bandwidth which could cause increasingly annoying and unpredictable problems when other devices are added to the home which compete with it for bandwidth.

As a final example used throughout the current discussion, consider a motor vehicle. Modern vehicles, even gasoline-powered ones, demand significant amounts of electrical power from the limited power-generation capability of the vehicles. As with the home example, these demands increase when features are added. Because many such devices make their demands without coordinating with other devices, in a worst-case scenario using resources to serve “secondary” goals such as playing the radio or using the vehicle to power an air compressor may deplete the electrical reserves to the extent that the “primary” goal of powering the vehicle along the road is impaired. Scarcity of electrical-power resources may be exacerbated when the vehicle is electrically powered.

To counter this possibility, aspects of the present disclosure monitor resource utilization within a machine-control environment, machine-learn from that monitoring in order to predict what levels of resource utilization may be expected in the future, and use the results of that learning to more effectively balance competing resource demands.

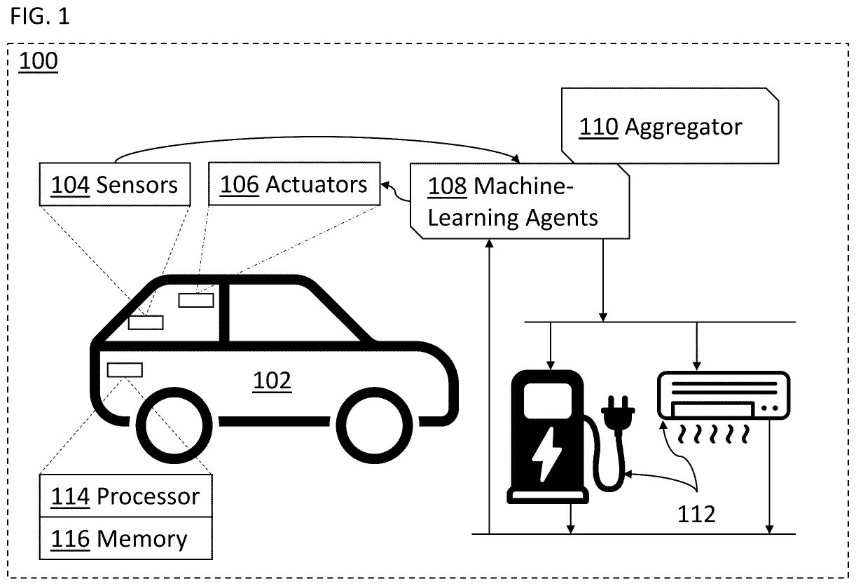

To begin examining these aspects in depth, turn to FIG. 1 which depicts an exemplary machine-control environment 100 focused on electrical-resource utilization in a vehicle 102. The vehicle 102 incorporates many devices, such as sensors 104 and actuators 106, that require resources from the vehicle 102 in order to operate. As is discussed in great detail in the text accompanying the remaining figures, machine-learning agents 108 and an aggregator 110 combine to coordinate how the devices 104/106 utilize the limited resources provided by the vehicle 102.

The set of devices to be controlled may extend beyond the sensors 104 and the actuators 106 that actually reside within the vehicle 102. To illustrate these “out of the vehicle” devices 112, FIG. 1 shows an electrical-charging station 112 and a home AC 112. Normally, the AC 112 would be powered by the local electrical-power grid (not shown), but in some circumstances, such as a power outage during a particularly hot day, a homeowner may choose to power the AC 112 from the battery pack in the vehicle 102. In this case, the home AC 112 competes with the devices 104/106 internal to the vehicle 102 for limited electrical-power resources, and that competition may be coordinated, according to aspects of the present disclosure, by the machine-learning agents 108 working with the aggregator 110.

So far, the present discussion has focused on resource consumption. To effectively manage that consumption, aspects of the present disclosure, in some embodiments, also monitor current resource levels, such as the charge level in the vehicle's battery pack, and resource replenishment. Generally speaking, the electrical-charging station 112 does not literally consume resources of the vehicle 102 but in fact replenishes those resources by recharging the vehicle's battery pack. Thus, when coordinating among competing resource demands, the machine-learning agents 108/aggregator 110 may use the information that the electrical-charging station 112 is connected to the vehicle 102 and its rate of recharging the battery pack.

In some embodiments, the machine-learning agents 108/aggregator 110 are supported by a computing architecture exemplified in FIG. 1 by a computer processor 114 and a computer memory 116. While shown as located within the vehicle 102, this computing architecture 114/116 may be located anywhere for convenience' sake: within the vehicle 102 as illustrated in FIG. 1, in a local computer communicatively connected to the vehicle 102, or in a computer-networking cloud. To prevent a long interruption in the narrative flow, further aspects of the computing architecture 114/116 are discussed below near the end of this Detailed Description.

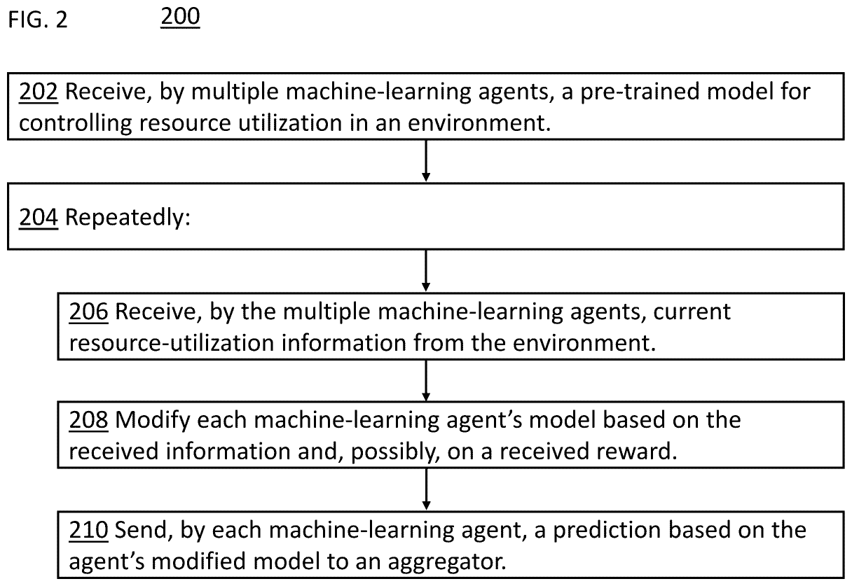

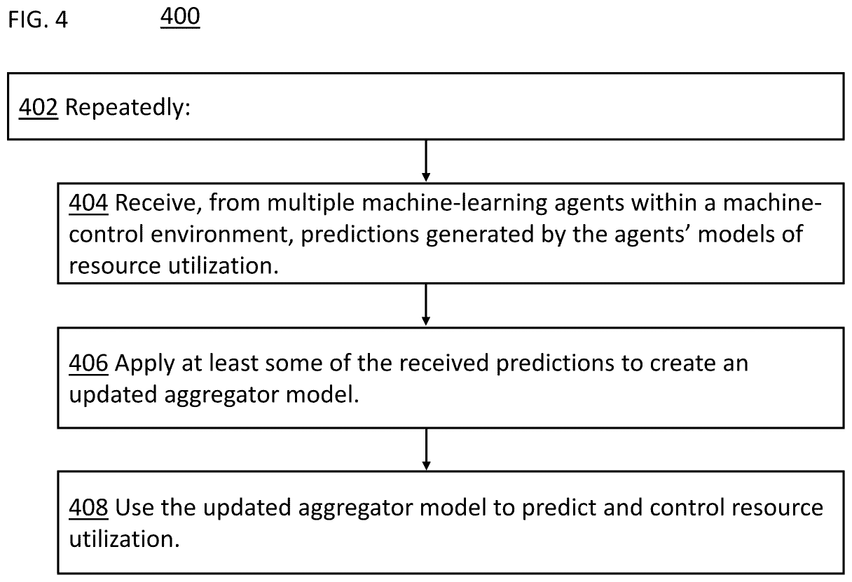

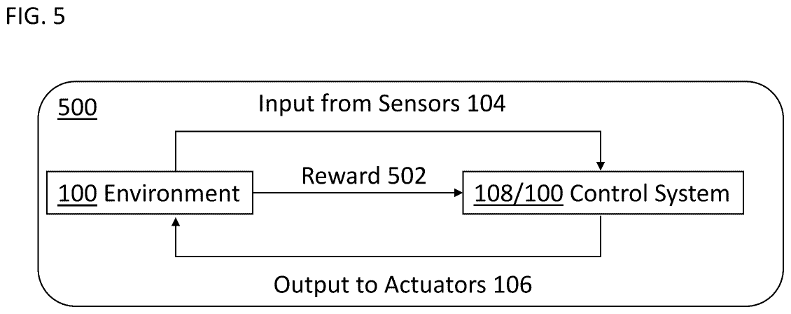

The discussion now focuses on the machine-learning agents 108 and the aggregator 110. FIG. 2 presents an exemplary method 200 usable by machine-learning agents 108 in some embodiments, while FIG. 4 presents the aggregator 110. The discussion accompanying FIGS. 5 through 7 then shows how the agents 108 and aggregator 110 work together as one system.

Turning to FIG. 2, in a typical embodiment the method 200 is applied while one specific operator is operating in the machine-control environment 100. The method 200 is run again for each anticipated operator.

Leaving aside step 202 for the moment, step 204 is a loop that may be repeated indefinitely.

In the first step 206 of the loop 204, multiple machine-learning agents 108 receive information about the current status of resource utilization within the machine-control environment 100. Again turning to the example of the vehicle 102, this information may include which devices 104/106/112 are currently drawing on electrical resources or replenishing them. Also collected is information about the timing of such utilization which may be used to forecast historical resource-utilization trends for the one specific operator. The machine-learning agents 108 may gather information on how the current operator typical drives, important both for predicting resource-utilization (especially when the vehicle 102 is electrically powered) and for predicting resource-replenishment (e.g., for an electrically powered vehicle 102 charging its battery pack). Other operator-specific information may include the likelihood of this operator running the vehicle or home AC 112 given the outside air temperature and humidity, how long the operator is likely to run the AC, how long this operator typically parks while powering devices 104/106/112 or some subset of them, and the like.

In step 208, the machine-learning agents 108 apply techniques of machine learning to modify their internal models of how resources are utilized when this one specific operator is operating in the machine-control environment 100. Details of this machine learning are discussed below. To sum up that discussion for some embodiments, this learning includes taking the data received in step 206 (and in previous iterations of step 206 as the loop 204 repeats), running those data through an internal model to produce a prediction for future resource utilization, receiving feedback on how well that prediction matches reality, and “tweaking” the agent's internal model to bring its future predictions closer to reality.

In step 210, the predictions made by the machine-learning agents 108 are sent to the aggregator 110 whose operation is discussed below with reference to FIG. 4.

Note that the discussion accompanying FIG. 2 mentions “machine-learning agents 108” in the plural. While it is true that machine learning may occur with just one agent 108, aspects of the present disclosure tend to use multiple agents 108 in parallel. This parallelization, when combined with the aggregator 110, greatly speeds up the learning process and thus makes embodiments of the present disclosure more responsive to the operator of the machine-control environment 100. In some embodiments applicable to some specific machine-control environments 100, each resource (e.g., electrical power, communications bandwidth, cooling) is modeled by its own set of a few machine-learning agents 108 operating in parallel.

At this point, the discussion returns to the first step 202 of the method 200. An issue with many machine-learning methods is that they use tiny, incremental steps when they are improving their model. For example, and as discussed above in relation to step 208, a machine-learning agent 108 notes the difference between its prediction and the actual result but “tweaks” its environmental-control model to move it very slightly toward producing that actual result. By taking tiny steps, this learning process makes the agent's convergence toward a near-optimal model a very slow process. This slowness is useful in preventing the model from taking too large a step and thus “overstepping” and missing the best possible configuration. It is also useful to help make the model robust in widely differing situations rather than optimal for the specific situations which the agent 108 has seen and reacted to.

While the above are reasons for slow learning, the actual fact of slowness is not itself a virtue. That is, if the machine-control environment 100 changes slightly by adding a new device 104/106/112, or if the one specific operator changes his behavior for some reason, a slowly learning system of machine-learning agents 108 and aggregator 110 may respond to these changes so slowly that it may not keep up and may become at best worthless.

One method for speeding up learning is discussed above: Apply multiple machine-learning agents 108 in parallel. Another method is the reason for step 202. Here, each machine-learning agent 108 does not start learning from a “blank slate” but is initialized with a pre-trained model that is at least somewhat reasonable for the task at hand.

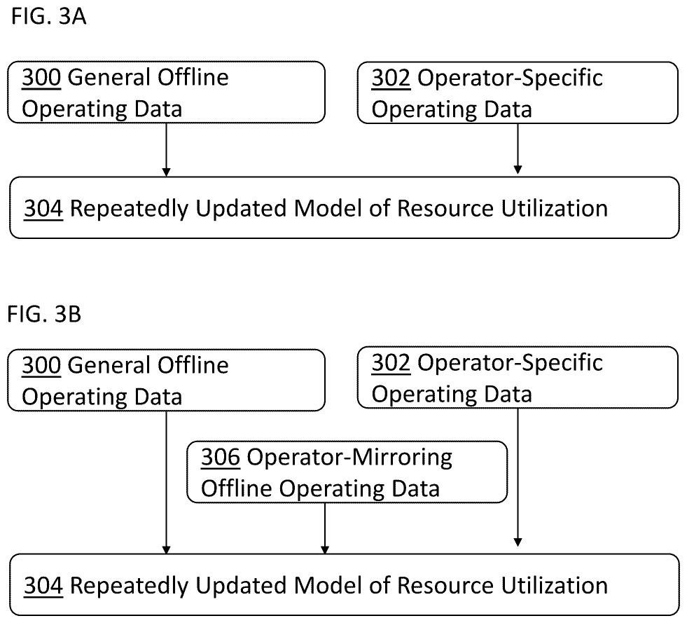

FIGS. 3A and 3B illustrate these pre-trained models. In some embodiments, each machine-learning agent 108 starts by being pre-trained with data 300 that are developed in a virtual environment. These pre-training data 300 are created by running multiple scenarios that reasonably mimic expected resource utilization in the target machine-control environment 100. These simulations may cover many, many scenarios and may be created covering expected behaviors of a number of virtual operators expected in the environment 100. Turning to the standard example, multiple operators of a vehicle 102 are simulated in multiple driving and parking situations. These simulations are fed to the machine-learning agent 108 that updates its model just as it will later do with the “live” data 302. The resultant model is improved based on learning from hundreds or thousands of simulated driving and parking hours. Thus, when this pre-trained model is combined with the “live” learning data 302 (the focus of step 206 of FIG. 2), the agent 108 starts with a reasonable, albeit operator-agnostic, model 304, and that model 304 matures much more quickly than it could without the pre-training data 300.

If there is already some data about the behavioral characteristics of the one specific operator that the machine-learning agent 108 is trying to learn to predict, then FIG. 3B takes the pre-training data of FIG. 3A one step further. Again, simulations of the machine-control environment 100 are run, but this time they are based on characteristics of virtual operators deemed to have characteristics similar to those of the target operator. Again, these simulations are used by the agent 108 to update its internal model. Because that agent 108 is pre-trained with both the “generic operator” training data 300 of FIG. 3A and with the more specific operator data 306, the agent's model starts as a close approximation to the targeted operator and from there improves its already close model with “live” data 302 (as discussed above in reference to FIG. 2).

To provide a diversity of machine-learning agents 108 that will increase the overall learning rate of the combined system of agents 108 and aggregator 110, the agents 108 are not pre-trained with exactly the same data 300/306. Instead, each agent 108 is pre-trained with a subset of the pretraining data 300/306. Thus, according to aspects of the present disclosure, pre-training by itself plus pre-training to create a diversity of agents 108 are both useful tools for improving the learning rate whether the combined control system 108/110 is learning about this one specific operator for the first time or whether it is changing its learning to adapt to new characteristics of the machine-learning environment 100 or of the one specific operator. The use of different agents 108 may also improve the stability of the combined control system 108/110 in the face of changes in the machine-control environment 100.

The aggregator 110, in some embodiments, performs the method 400 of FIG. 4. The loop of step 402 is repeated indefinitely.

In step 404, the aggregator 110 receives predictions from one or more machine-learning agents 108. These are the predictions created from the agents' internal models in step 210 of FIG. 2.

In step 406, the aggregator 110 uses at least some of the received predictions to update its own model for controlling resource utilization within the machine-control environment 100. In different embodiments, the aggregator 110 uses different techniques to update its model. In one technique, the aggregator 110 compares the predictions received from the machine-learning agents 108 and selects the most commonly made prediction. Using a majority voting scheme, the agent 108 that most often produces the most common prediction is chosen by the aggregator 110 as the best agent 108, and that agent's model is taken over to be the aggregator's updated model.

In another technique, the aggregator 110 runs one machine-learning agent 108 during a set period. The aggregator 110 repeats this with the other agents 108. Once the agents 108 have been run, the aggregator 110 picks that agent 108 whose prediction performance was best, by some measure, and uses that agent's model as the updated aggregator model.

The aggregator 110 uses its updated model in step 408 to control how limited resources are allocated among the devices 104/106/112 competing for those resources. As one example, if the charge level of an electrically powered vehicle's battery pack is getting low, but the aggregator's updated model predicts that, based on the historic behavior of this specific operator, the vehicle 102 will probably need to be driven a significant distance very soon, then the aggregator 110 may conserve resources by denying resource requests from some of the devices 104/106/112 or give them less than the amount they are requesting. In some embodiments, the aggregator 110 may alert the operator to the status of the monitored resource so that the operator may, for instance, plug into the electrical-charging station 112.

As the loop of step 402 repeats, the combined control system 108/110 better learns the behaviors of the specific operator and comes closer to optimizing resource utilization within the machine-control environment 100 to support those behaviors.

In some embodiments, the combined control system 108/110 may be implemented using “reinforcement learning.” This reinforcement learning is illustrated schematically by the data flows of FIG. 5. The control system 108/110 operates in its own “world” 500. As discussed above in the text accompanying FIG. 1, the machine-control environment 100 provides machine-learning agents 108 with information 302 from the sensors 104. Additionally, the environment 100 uses a reward 502 to tell the control system 108/110 how well its environmental-control model is performing. The reward 502 may be positive or negative. The control system 108/110 considers the reward 502 when adjusting its model, and uses its adjusted model to control aspects of the environment 100 by directing the actuators 106 (step 408 of FIG. 4). The control system's cycle of receiving environmental information 302 and rewards 502 and improving its environmental-control model is repeated indefinitely.

In more detail, for some embodiments, the control system 108/110 tries to maximize the rewards 502 it receives over time. There are several ways to do this. In one way, the rewards 502 are maximized using a discounted return:

$${G}_{t} ≅ {Σ}_{i = 0}^{∞} {γ}^{i} {R}_{t + i + 1}$$

where γ is the discount rate and R is the reward at a given time. The rewards 502 are designed to make the control system 108/110 act in ways deemed to be beneficial, such as improving efficiency in resource utilization and providing convenience to the operator. Conversely, negative rewards 502 are given to penalize unwanted behavior by the control system 108/110 such as attempting to use the electrical-charging station 112 when the vehicle 102 is either fully charged or not plugged in or using excessive amounts of a monitored resource. In other examples, an electrical-resource use may reap at least a small negative reward 502, thus encouraging the control system 108/110 to recharge the battery pack when the vehicle 102 is not in use. The control system 108/110 is also encouraged to maintain a sufficient charge level for the operator's usual needs but also somewhat more to ensure a comfortable margin and thus alleviate range anxiety.

A concrete example of how rewards 502 may be calculated in reinforcement learning is provided by this partial code snippet:

| | |
|---|---|
| Input: | Cₛᵤₘ : electrical consumption |
| | Pₑ : price of electricity, e.g., $/kilowatt-hour |
| Output: | R: reward |

```
At each time step, do:
  if charger is on then:
      if vehicle is not present then:
        R ← −5 × Cₛᵤₘ × Pₑ
      else if vehicle is fully charged then:
        R ← −2.5 × Cₛᵤₘ × Pₑ
      else:
        R ← −Cₛᵤₘ × Pₑ
  if battery range is below daily driving range then:
      R ← −2
  if battery charge level is below 40% then:
      R ← −5
  end
```

This is an illustrative example, and specific reward mechanisms may be designed specifically for each machine-control environment 100.

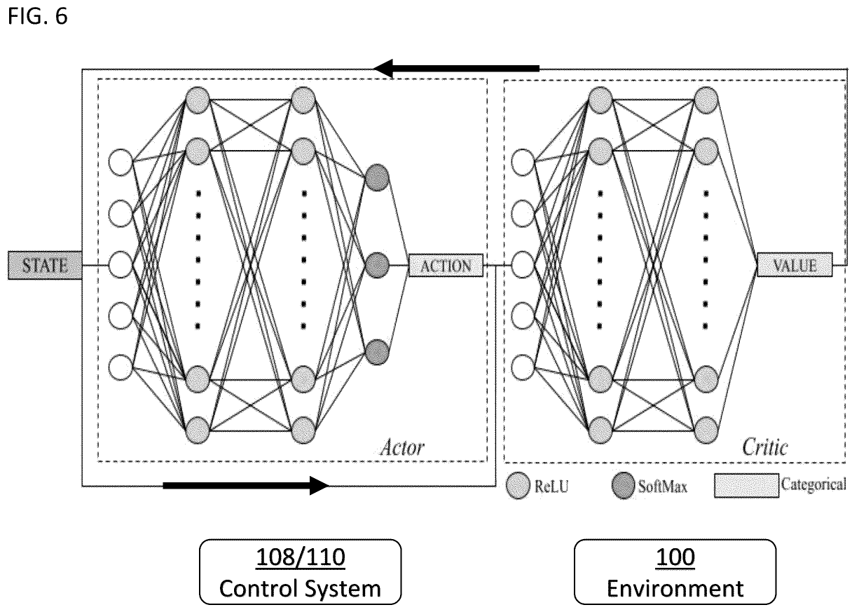

The reinforcement learning techniques illustrated in FIG. 5 and the accompanying text may be implemented using a pair of neural networks as shown in FIG. 6. Here, the control system 108/110 is called the “Actor.” Information 302 about the current status of the machine-control environment 100 enters the control system 108/110 on the left side of FIG. 6. As with many deep neural networks, this information is processed through layers of weights to produce a list of possible outputs. One of these possibilities is chosen and becomes the action that the control system 108/110 uses to control some aspect of the environment 100.

In the particular embodiment shown in FIG. 6, when the action is received by the machine-control environment 100 (the “Critic”), it is fed into another neural network, processed by the weights in that network, and a value is produced. This value may be the same as the reward 502 of FIG. 5 and is fed back as another input into the control system 108/110. As this process continues, learning is achieved when the weights in each neural network are adjusted.

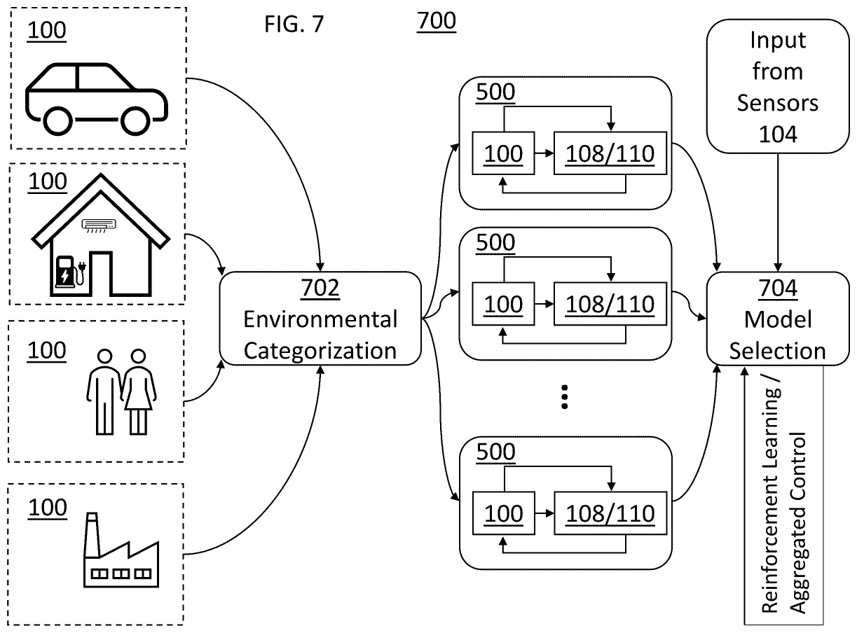

FIG. 7 puts the above aspects into a larger context 700. On the left of FIG. 7 are illustrations from the great diversity of machine-control environments 100. This diversity is first managed by categorizing 702 the environments 100. Each category may require its own specific adjustments to the aspects of the present disclosure to tailor those aspects to best fit the requirements of that category or of each specific environment 100.

Multiple pre-training “worlds” 500 are set up. In each one, a control system 108/110 is uniquely pre-trained. Then the various control systems 108/110 are set to operate in the chosen machine-control environment 100, receiving status information 302 from the sensors 104 in the environment 100, and updating their internal predication models. Periodically, the performances of the various control systems 108/100 are compared, and the best one is selected 704 to control the resources within the environment 100.

As reinforcement learning continues, each model gets better, and the selection process for the best model is repeated. The non-selected models may sometimes be “revived”: When circumstances within the machine-control environment 100 change, one of the non-selected models may be performing better than the best model from before the circumstances changed. In that case, the previously non-selected model becomes the chosen model that controls resources, and the learning continues from there.

Return to the computer processor 114 and the computer memory 116 of FIG. 1. Together, they represent a computing architecture that may support the control system of the machine-learning agents 108 and the aggregator 110. Specifically, the computer processor 114 may include one or more computer processors local to the machine-control environment 100, remote from it as in a cloud-computing scenario, or a combination working together. The memory 116 may also be local, remote, or a combination. The computer processor 114 and memory 116 may be connected via a local bus or by a communications system that may be wired, wireless, or optical. Other devices, including in some cases the devices 104/106/112 may be communicatively connected to the computer processor 114 and the memory 116. Software running on the computer processor 114 and stored in the memory 116 includes an operating system and the code specific to the control system 108/110.

In view of the many possible embodiments to which the principles of the present discussion may be applied, it should be recognized that the embodiments described herein with respect to the drawing figures are meant to be illustrative and should not be taken as limiting the scope of the claims. Therefore, the techniques as described herein contemplate such embodiments as may come within the scope of the following claims and equivalents thereof.

What is claimed is:

1. A vehicle comprising:
at least one computer processor;
a non-transitory computer-storage medium (“memory”) communicatively coupled to the computer processor;
a plurality of machine-learning agents, each machine-learning agent comprising instructions stored in the memory and executable by the at least one computer processor to perform a method for:
receiving a pre-trained model as an initial model;
receiving information about an operating environment of the vehicle, the received information including resource-utilization information;
modifying a model of the machine-learning agent based on at least some of the received information; and
sending a prediction based on the modified model of the machine-learning agent to an aggregator; and
the aggregator comprising instructions stored in the memory and executable by the at least one computer processor to perform a method for:
receiving from at least some machine-learning agents predictions based on their modified models;
applying at least some of the received predictions to create an updated aggregator model; and
using the updated aggregator model to predict and control utilization of a resource in the operating environment of the vehicle.

2. The vehicle of claim 1 wherein the resource is selected from the group consisting of: electrical power, electrical energy, cooling, communications bandwidth, and computer-processing power.

3. The vehicle of claim 1 wherein the method of the plurality of machine-learning agents is performed while one specific operator is operating the vehicle, and wherein the updated aggregator model is associated with the one specific operator.

4. The vehicle of claim 3 wherein the pre-trained model of each machine-learning agent is created based on simulations of a plurality of virtual operators of the vehicle.

5. The vehicle of claim 3 wherein the pre-trained model of each machine-learning agent is created based on a simulation of a virtual operator of the vehicle whose operating characteristics are chosen to be similar to those of the one specific operator.

6. The vehicle of claim 1 wherein applying at least some of the received predictions to create an updated aggregator model comprises:
setting an interim updated aggregator model that uses as its prediction the most common of the received predictions; and
creating the updated aggregator model as an updated machine-learning agent model that most often produced the most common of the received predictions.

7. The vehicle of claim 1 wherein applying at least some of the received predictions to create an updated aggregator model comprises:
for each of the plurality of machine-learning agents, running that agent in the operating environment of the vehicle for a period of time;
evaluating each machine-learning agent's performance over its period of time; and
creating the updated aggregator model as an updated machine-learning agent model that performed best over its period of time.

8. A system configured to operate in a machine-control environment, the system comprising:
at least one computer processor;
a a non-transitory computer-storage medium (“memory”) communicatively coupled to the computer processor;
a plurality of machine-learning agents, each machine-learning agent comprising instructions stored in the memory and executable by the at least one computer processor to perform a method for:
receiving a pre-trained model as an initial model;
receiving information about the machine-control environment, the received information including resource-utilization information;
modifying a model of the machine-learning agent based on at least some of the received information; and
sending a prediction based on the modified model of the machine-learning agent to an aggregator; and
the aggregator comprising instructions stored in the memory and executable by the at least one computer processor to perform a method for:
receiving from at least some machine-learning agents predictions based on their modified models;
applying at least some of the received predictions to create an updated aggregator model; and
using the updated aggregator model to predict and control utilization of a resource in the machine-control environment.

9. The system of claim 8 wherein the system comprises an element selected from the group consisting of: a dwelling place, an office, an industrial machine, a farm machine, and a computer server.

10. The system of claim 8 wherein the resource is selected from the group consisting of: electrical power, electrical energy, cooling, communications bandwidth, and computer-processing power.

11. The system of claim 8 wherein the method of the plurality of machine-learning agents is performed while one specific operator is operating the system, and wherein the updated aggregator model is associated with the one specific operator.

12. The system of claim 11 wherein the pre-trained model of each machine-learning agent is created based on simulations of a plurality of virtual operators of the system.

13. The system of claim 11 wherein the pre-trained model of each machine-learning agent is created based on a simulation of a virtual operator of the system whose operating characteristics are chosen to be similar to those of the one specific operator.

14. The system of claim 8 wherein applying at least some of the received predictions to create an updated aggregator model comprises:
setting an interim updated aggregator model that uses as its prediction the most common of the received predictions; and
creating the updated aggregator model as an updated machine-learning agent model that most often produced the most common of the received predictions.

15. The system of claim 8 wherein applying at least some of the received predictions to create an updated aggregator model comprises:
for each of the plurality of machine-learning agents, running that agent in the machine-control environment for a period of time;
evaluating each machine-learning agent's performance over its period of time; and
creating the updated aggregator model as an updated machine-learning agent model that performed best over its period of time.

16. An aggregator configured to operate in a machine-control environment comprising at least one computer processor and a a non-transitory computer-storage medium (“memory”) communicatively coupled to the computer processor, the aggregator comprising:
instructions stored in the memory and executable by the at least one computer processor to perform a method for:
receiving from a plurality of machine-learning agents predictions based on their modified models;
applying at least some of the received predictions to create an updated aggregator model; and
using the updated aggregator model to predict and control utilization of a resource in the machine-control environment.

17. The aggregator of claim 16 wherein the resource is selected from the group consisting of: electrical power, electrical energy, cooling, communications bandwidth, and computer-processing power.

18. The aggregator of claim 16 wherein receiving from a plurality of machine-learning agents predictions based on their modified models is performed while one specific operator is operating within the machine-control environment, and wherein the updated aggregator model is associated with the one specific operator.

19. The aggregator of claim 16 wherein applying at least some of the received predictions to create an updated aggregator model comprises:
setting an interim updated aggregator model that uses as its prediction the most common of the received predictions; and
creating the updated aggregator model as an updated machine-learning agent model that most often produced the most common of the received predictions.

20. The aggregator of claim 16 wherein applying at least some of the received predictions to create an updated aggregator model comprises:
for each of the plurality of machine-learning agents, running that agent in the machine-control environment for a period of time;
evaluating each machine-learning agent's performance over its period of time; and
creating the updated aggregator model as an updated machine-learning agent model that performed best over its period of time.
